(19) United States
(12) Patent Application Publication
(10) Pub. No.: US 2007/0205308 A1
(43) Pub. Date: Sep. 6, 2007

(54) Snow removal device

(75) Inventor: Seiji Nishida, Minato-ku (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Nishida Company

(21) Appl. No.: 11/710,478

(22) Filed: Feb. 26, 2007

(30) Foreign Application Priority Data
Feb. 28, 2006 (JP) 2006-86481
Dec. 1, 2006 (JP) 2006-9778

(51) Int. Cl. B05B 15/00; B05B 1/14; A62C 2/08

(52) U.S. Cl. 239/547; 239/548; 239/550

(57) ABSTRACT

A snow removal device is provided for a building having sidewalls and a sloping roof with at least one of a ridge and a corner ridge. The snow removal device includes a hot water heater, a pressurization pump in fluid communication with the hot water heater, a connection pipe, a water discharge pipe connected to the hot water heater via the connection pipe, the water discharge pipe being configured to be installed in a direction along the ridge or the corner ridge, the water discharge pipe having horizontal or downwardly sloping water discharge apertures and downwardly facing water release apertures, the water discharge pipe being fixed to the building by brackets positioned to be higher than the ridge or the corner ridge.

### CROSS REFERENCE TO RELATED APPLICATION

This application is based upon and claims the benefit of priority from Japanese Patent Application No. 2006-86481, filed on Feb. 28, 2006 and Japanese Utility Model Application No. No. 2006-9778, filed on Dec. 1, 2006, the entire contents of which are incorporated herein by reference.

### FIELD OF THE INVENTION

The present invention relates to a snow removal device that can safely, easily, and quickly remove snowdrifts that have accumulated on a roof of a building in regions of snowfall.

### BACKGROUND

As is well known, snowdrifts that have accumulated on a roof in regions of snowfall are removed by the effort of individuals climbing on the roof and sweeping off the snow to the ground. Such snow removal requires effort and is dangerous, which makes it a serious burden for the elderly and the like. Moreover, the annual contractual expense for snow removal can be significantly high.

A device having a laminated or coiled heating source running along the inclined direction of the roof at an edge of eaves, where ice-bars form on the back side of the roof, has been proposed to address the problems (See Japanese Laid-open Publication S54-31338, pages 1-5, FIGS. 2 to 4.)

A roof-snow removal device provided with a heat exchanger that generates steam and hot air from stove waste heat, a pressurization device that mixes and pressurizes the steam and hot air generated by the heat exchanger, and steam and hot air channels placed along a roof that spray the steam and hot air from the pressurization device through a plurality of spray ports has also been proposed. (See Japanese Laid-open Publication H01-235781, pages 1-5, FIGS. 1 to 6.)

However, the device disclosed in Japanese Laid-open Publication S54-31338 is merely a device capable of melting and draining ice bars formed from melted snow water collected on the roof that had frozen by a heat source, but it is unsuitable for removing snowdrifts accumulated on the roof. Moreover, its heat efficiency is low, and it is prone to mechanical damage by the accumulated snow since the heat source is mounted from the ridge of the roof to the edge of the eaves. Furthermore, the snow removal device disclosed in Japanese Laid-open Publication H01-235781 requires a stove, a heat exchanger, a water conveyance apparatus, an air conveyance apparatus, a pressure conveyance apparatus, and spray passages for steam and hot air. Consequently, the overall device structure suffers from numerous defects, including its complexity, high cost, and high operating expenses.

The present invention addresses the above problems and provides a snow removal device that can safely, easily, and quickly remove snowdrifts accumulated on a roof of a building, and that can be operated easily and produced or constructed at low cost.

### SUMMARY OF THE INVENTION

A snow removal device is provided for a building having sidewalls and a sloping roof with at least one of a ridge and a corner ridge. The snow removal device includes a hot water heater, a pressurization pump in fluid communication with the hot water heater, a connection pipe, a water discharge pipe connected to the hot water heater via the connection pipe, the water discharge pipe being configured to be installed in a direction along the ridge or the corner ridge, the water discharge pipe having horizontal or downwardly sloping water discharge apertures and downwardly facing water release apertures, the water discharge pipe being fixed to the building by brackets positioned to be higher than the ridge or the corner ridge.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 is a perspective view showing a gabled roof building fitted with the snow removal device according to one embodiment of the present invention;

FIG. 2A is a side partial view of the building shown in FIG. 1;

FIG. 2B is a vertical cross-sectional partial view of the building shown in FIG. 1;

FIG. 3 is a perspective view showing a water discharge pipe used in the snow removal device;

FIG. 4 is a vertical cross-sectional view of the water discharge pipe along the longitudinal direction;

FIG. 5 is a vertical cross-sectional view of the water discharge pipe along the direction orthogonal to the longitudinal direction;

FIG. 6 is a vertical cross-sectional view of another embodiment of the water discharge pipe;

FIG. 7 is a vertical cross-sectional view of another embodiment of the water discharge pipe;

FIG. 8 is a vertical view of a portion of the roof shown in FIG. 1;

FIG. 9 is a vertical view of the snow removal device of FIG. 1 in operation;

FIG. 10 is a vertical view of a single-sided slanting roof;

FIG. 11 is a perspective view of a building with a hipped roof having another embodiment of the snow removal device;

FIG. 12 is a perspective view of the snow removal device of FIG. 11 in operation;

FIG. 13 is a perspective view of a building with a square roof having another embodiment of the snow removal device;

FIG. 14 is a perspective view of the snow removal device of FIG. 13 in operation;

FIG. 15 is a perspective view of a building with a gabled roof having another embodiment of the snow removal device;

FIG. 16 is a perspective view of a building with a hipped roof having another embodiment of the snow removal device; and

FIG. 17 is a perspective view of a square roof having another embodiment of the snow removal device.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

According to one embodiment of the invention, a snow removal device includes a hot water heater, a pressurization pump in fluid communication with the hot water heater, a connection pipe, a water discharge pipe connected to the hot water heater via the connection pipe, the water discharge pipe being configured to be installed in a direction along the ridge or the corner ridge, the water discharge pipe having horizontal or downwardly sloping water discharge apertures and downwardly facing water release apertures, the water discharge pipe being fixed to the building by brackets positioned to be higher than the ridge or the corner ridge. In one embodiment, the water discharge pipe may be piped at a position approximately 20 to 30 cm higher than the ridge or corner ridge of the roof. The height of the pipe from the ridge or corner ridge may be determined based on local snow accumulation conditions and safety requirements.

In addition, the connection pipe may rise from a sidewall of the building and links to the water discharge pipes at the top edge. Furthermore, the connection pipe linked to the hot water heater may rise near the center in a planar view of the roof from the building and links to a plurality of water discharge pipe portions that branch along at least one of the ridge and the corner ridge. Moreover, the snow removal device may include a water release valve mounted in the connection pipe connecting the water discharge pipes and the hot water heater. Additionally, the water discharge apertures and the water release apertures are formed in the water discharge pipe at predetermined pitches. The pitches of the water discharge apertures are set smaller than the pitches of the water release apertures. Also, the hot water heater may be housed within a closable case that has a door capable of opening/closing. The case may be made of a metal or a thermal insulating material and be able to close in an air tight manner when the door is closed. In addition, the snow removal device may have a snowfall sensor mounted above at least one of the ridge of the roof and the corner ridge and below the water discharge pipe. In one embodiment, the sensor may detect a snowfall when a light or signal reception is blocked by fallen snow. The height of the snowfall sensor may be positioned directly below (several cm to 5 cm) the water discharge pipe.

In one embodiment of the snow removal device, hot water heated by the hot water heater is fed to the water discharge pipe via a pressurization pump so as to expel snowdrifts that had accumulated on the roof via water discharge apertures in the water discharge pipes. Since such discharged hot water flows down toward the edge of the eaves along the incline of the roof while melting the snowdrifts, it gradually melts the entire snowdrift down to the base. As a result, snowdrifts that had accumulated on the roof are moved to the edge of the roof along its incline and are then dropped to the ground. Furthermore, snowdrifts that had accumulated on the roof can be reliably melted and removed by the hot water since cooling of the hot water supplied from the hot water heater can be prevented by the insulation cover. Moreover, freezing of the water discharge pipes themselves can be prevented since the hot water remaining in the water discharge pipes following snow removal is drained through the water release apertures that are directed downward. It may be desirable to check to see if people are present below the eaves during the snow removal.

The water discharge pipe may be mounted via brackets at a position higher than the ridge of a gabled roof, the ridge and corner ridge of a hipped roof (slanted ridge line), or at each corner ridge of a square roof. By so doing, snowdrifts that had accumulated on the roof can be reliably melted by the hot water. Consequently, the snow removal device can safely, easily, and quickly remove snowdrifts that have accumulated on the roof of a building, can be maintained simply, can be operated by anyone, can be produced or constructed at low cost, and has low operating costs.

Roofs that are suitable for the snow removal device according to the present invention include any inclined roofs that have at least a ridge or corner ridge, and include the gabled roof, hipped roof, gabled-hipped roof, bowed roof (roof in which the slant angle is two-story steep), as well as tiled roofs. The hot water heater may be a gas-fired hot water heater as well as a boiler heated by petroleum, firewood or coal, or a combination of a heater that uses fuel such as firewood with a heat exchanger. The hot water heater and the pressurization pump can be easily mounted inside adjacent to one side of the building in the snow removal device. The connection pipe connected outside to the hot water heater rises near the center in the planar view of the roof and is connected to a plurality of water discharge pipes that branch at that region in the snow removal device. Accordingly, snowdrifts that had accumulated on the roof can be reliably and evenly removed since hot water can be provided at uniform pressure to the entire plurality of water discharge pipes even when the roof ridge is long. Moreover, freezing of the connection pipes themselves can be prevented since the hot water remaining in the connection pipes is drained through the water release valve in the snow removal device. In addition, hot water can be uniformly discharged over the roof from water discharge apertures directed obliquely downward or horizontally that are formed at comparatively small pitches, and snow that had accumulated on the ridge or corner ridge of a roof directly below the water release apertures formed at a greater pitch can be reliably melted and removed by the snow removal device.

In addition, the snow removal device may have a door that, when closed, enables it to be sealed from the interior of the building for safety to protect the inhabitants from an incomplete combustion state of the hot water heater. Also, the inhabitants can be warned by a buzzer, etc., if a light signal to the photoreceptor of the snowfall sensor is blocked or if the reception of infrared rays or radio waves is obstructed, and snow removal can be accurately timed by operating the hot water heater or pump in the snow removal device. Moreover, if a light signal to the photoreceptor of the snowfall sensor is blocked, snowdrifts that had accumulated on the roof can be automatically removed by automatic actuation of the hot water heater and pressurization pump, etc. Moreover, the hot water heater or pressurization pump can be automatically shut down after a certain time duration predetermined by a timer once snow has been removed or the reception of light or infrared rays has resumed. This is ideal for elderly or single-inhabitant households as it requires no effort.

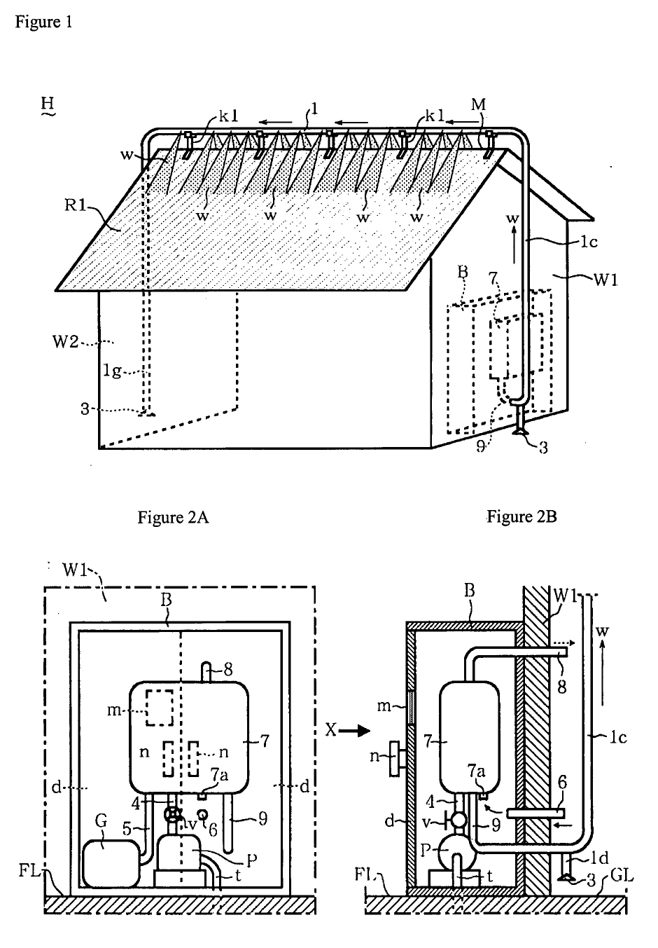

FIG. 1 is a perspective view at virtually a horizontal view of a building H fitted with the snow removal device pursuant to one embodiment of the present invention. FIGS. 2A and 2B are a vertical cross-sectional view of a narrow side W1 of building H and a partial side view. FIG. 2A depicts the view of FIG. 2A in the direction of arrow X. Hot water heater 7, pressurization pump P and gas cylinder G are mounted inside of the building near narrow side W1 where snow accumulation on building H is slight as shown in FIGS. 1 and 2A-B. Pressurization pump P provides water supplied via water-source pipe t that is erected from below the floor to hot water heater 7 via feedwater pipe 4 fitted with a water cutoff valve v. In addition, hot water heater 7 is linked via hot water pipe 9 to connection pipe 1c that rises along narrow side W1. Hot water heater 7 may be a domestic gas hot water heater having a capacity of 16 liters/minute or 20 liters/minute. A commercial hot water heater having larger diameter piping may also be used.

As shown in FIGS. 2A-B, gas feed pipe 5, air intake pipe 7a, and gas exhaust pipe 8 are connected to hot water heater 7. Air intake pipe 7a is positioned near the inside of ambient air induction pipe 6 so as to induct ambient air, and gas exhaust pipe 8 releases consumed gas outside through side wall W1. Gas feed pipe 5 is connected to gas cylinder G containing LPG or LNG.

Specifically, hot water heater 7 is provided with gas such as LPG from gas feed pipe 5. The gas is burned via ambient air that is provided via ambient air induction pipe 6 and air intake pipe 7a, and the water fed from feedwater pipe 4 via pressurization pump P that is heated by the resulting heat is turned into hot water w that is fed to water discharge pipe 1 outside through hot water pipe 9.

Hot water heater 7, pressurization pump P, and gas cylinder G are housed inside case B near or in contact with the back wall of narrow side W1. The case B may be made of a metal or a thermal insulating material, and it can be closed to seal the interior of the building from outside when a pair of double doors d, d are closed on the inside. Knob n is fitted on the outside to each door d and a peek window m allowing observation of the meter on hot water heater 7 is installed on the pair of doors d. The effects of snow can be inhibited by deploying hot water heater 7 and pressurization pump P, etc., on the narrow side (lateral wall W1) of building H, accidents due to incomplete gas combustion can be avoided and the appearance can be maintained by housing these in case B.

As shown in FIG. 1, connection pipe 1c that penetrates narrow side wall W1 from hot water pipe 9 and then rises vertically along that wall has water release valve 3 fitted to branch pipe 1d linked downwardly. The upper edge of connection pipe 1c is connected to one end of water discharge pipe 1 that is mounted above and along ridge M of gabled roof R1. Water discharge pipe 1 is mounted by a plurality of brackets k1 at a fixed pitch along ridge M of roof R1. The other end of water discharge pipe 1 is connected vertically along narrow side wall W2 on the opposite side to water drain pipe 1g that has water release valve 3 directed downwardly. Connection pipe 1c, branch pipe 1d, and water drain pipe 1g are covered by an insulating cover over the entire outer circumference of resin pipes discussed below.

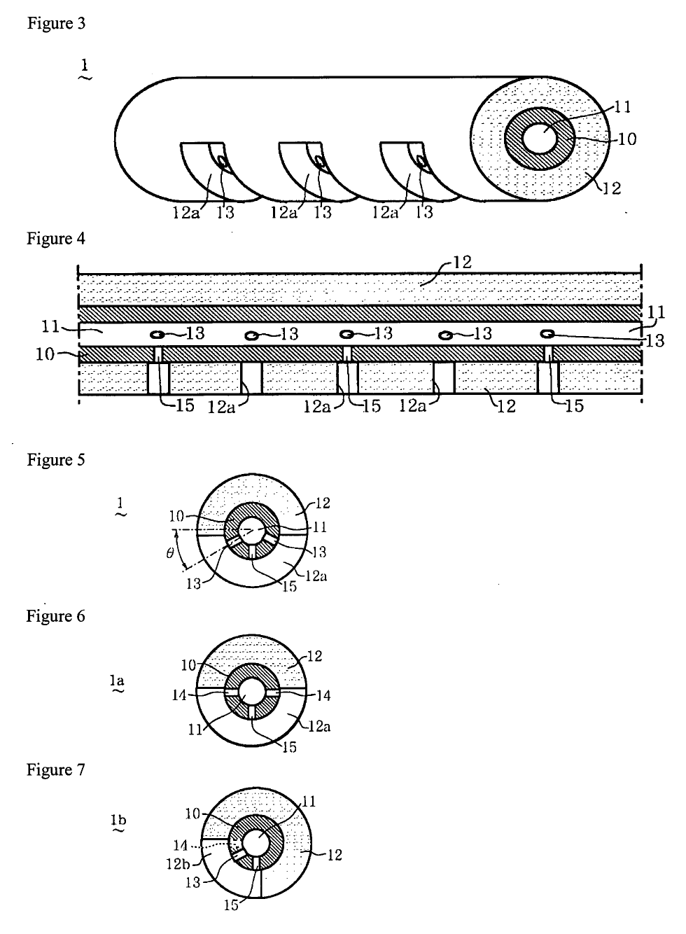

FIG. 3 is a partial perspective view of water discharge pipe 1. FIG. 4 and FIG. 5 are a vertical cross-sectional drawing along the axial direction of water discharge pipe 1 and a vertical cross-sectional drawing along the orthogonal direction, respectively. Water discharge pipe 1 may be heat resistant resin pipe (usually high-temperature pipe) 10 of vinyl chloride and insulation cover 12 wound about virtually the entire outer circumference, as shown in FIGS. 3 to 5. Resin pipe 10 has hollow core 11 with a round cross section along the entire length. A plurality of water discharge apertures 13 are formed with bilateral symmetry at a fixed pitch at a 30 degree angle θ relative to horizontal at a downward slant, and a plurality of water release apertures 15 facing downward are also formed at a longer pitch than the pitch. Water discharge apertures 13 and water release apertures 15 are opened on the inside of notch 12a having a virtually hemispherical profile formed in insulation cover 12. As shown in FIGS. 3 and 4, there are notches 12a opened on the inside only to water discharge apertures 13 and other that are opened to both water discharge apertures 13 and water release apertures 15. Insulation cover 12 is made of foaming resin or glass wool, for example, and its outer diameter is equal to or slightly thinker than that of resin pipe 10.

In this connection, water discharge pipe 1 is laid horizontally at height h approximately 20 to 30 cm above ridge M in gabled roof R1, and the pitch of adjacent water discharge apertures 13, 13 is recommended to be in the range of 410 to 450 mm when the inner diameter of hollow core 11 of the resin pipe 10 is 13 mm and the inner diameter of water discharge aperture 13 is 2 mm. Concurrently, the pitch of adjacent water release apertures 15, 15 is recommended to be in the range of 900 to 1230 mm when the inner diameter of water release apertures 15 is 2 mm. The total length of ridge M should be not more than 7 m under the conditions. The total length of ridge M is recommended to be not more than 10 m when the inner diameter of hollow core 11 of resin pipe 10 is 16 mm and the inner diameter of water discharge aperture 13 is 2 mm. The total length of ridge M is recommended to be not more than 17 m when the inner diameter of hollow core 11 of resin pipe 10 is 20 mm and the inner diameter of water discharge aperture 13 is 2 mm.

FIG. 6 is a cross-sectional drawing showing a water discharge pipe 1a according to another embodiment. The difference from the water discharge pipe 1 lies in the fact that a plurality of water discharge apertures 14 is formed with bilateral symmetry at the same pitch as above over the entire length of resin pipe 10. FIG. 7 is a cross-sectional drawing of a separate water discharge pipe 1b used in ridge M of a single-sided slanting roof R2 discussed below. The difference from the water discharge pipes 1, 1a lies in the fact that a plurality of downward slanted water discharge apertures 13 or horizontal water discharge apertures 14 is formed at the same pitch as above over the entire length of resin pipe 10 on only the left side. Round notch 12b is formed at a predetermined pitch in ¼ of the cross-section of insulation cover 12 to expose one or both of water discharge apertures 13 (water discharge aperture 14) and water release apertures 15 on the inside.

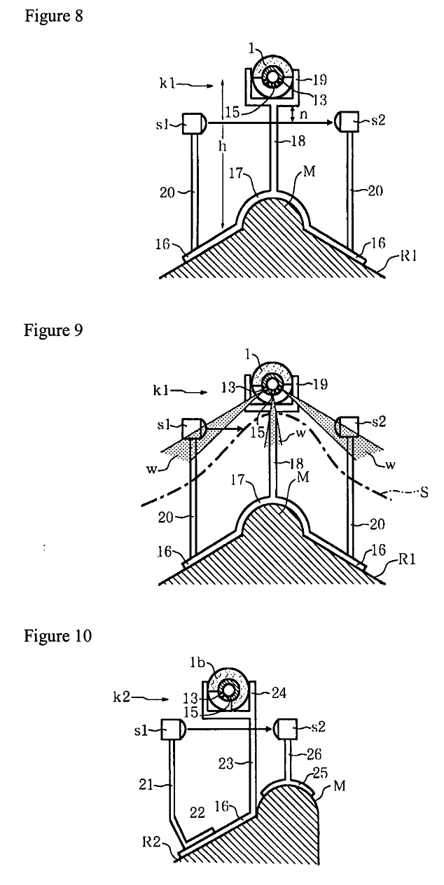

FIG. 8 is a vertical general view showing the vicinity of ridge M in gabled roof R1. As shown in FIG. 8, bracket k1 is furnished with a pair of slanted plates 16 laid on the left/right roof surface, radial section 17 connected thereto lying on virtually the outer shape of ridge M, brace member 18 set in the center thereof, and three-sided box-shaped member 19 positioned at the upper edge thereof that faces up. Water discharge pipe 1 is inserted in three-sided box-shaped member 19 and the water discharge pipe 1 is supported by wire that is the illustrated so that it cannot work loose. The size of bracket k1 is suitably selected so that the height h of the center of water discharge pipe 1 may be approximately 20 to 30 cm higher than the highest part of roof R1 excluding ridge M.

The snow removal device may be used in the following manner.

Hot water heater 7 may be operated in advance when continued snowfall is forecast. Hot water heater 7 may also be used for other applications during other seasons. When snow is seen to have accumulated to the height approaching water discharge pipe 1 on roof R1, water cutoff valve v is opened and water supplied by pressurization pump P is heated by hot water heater 7. The resulting hot water w is fed to hot water pipe 9 and then pumped through water discharge pipe 1 over ridge M on roof R1 via connection pipe 1c. The hot water w fed to water discharge pipe 1 is discharged over both sides of roof R1 linked by ridge M from downward slanted water discharge apertures 13, as shown in FIG. 1. The discharged hot water w gradually melts the snowdrifts to the bottom since the water flows down along the inclination of roof R1 to the eaves while melting the snowdrifts. Part of the hot water w flows down from water release apertures 15 and over roof R1 near ridge M.

As a result, the snowdrifts that had accumulated on roof R1 quickly move to the eaves (edges) along the incline of roof R1 and then fall onto the ground. The snowdrifts that had accumulated on roof R1 can be reliably melted and snow can be removed since cooling of hot water w fed from hot water heater 7 is avoided by insulation cover 12 during this period. The hot water remaining in water discharge pipe 1 after snow removal is drained from downward-facing water release apertures 15. The water discharge pipe 1a may be used instead of the water discharge pipe 1. Hot water heater 7 and pressurization pump P may be shut off following snow removal and water cutoff valve v may be closed. Freezing of water discharge pipe 1 (1a) can be prevented since hot water w remaining in connection pipe 1c is drained via water release valve 3 by opening water release valve 3. Snow that had accumulated on roof R1 can be reliably, safely, easily, and quickly removed through an operation that is simple even for the elderly or by a single individual.

Snowfall sensors may also be installed in the snow removal device according to one embodiment. As shown in FIG. 8, posts 20 of identical height are erected before or behind the brackets k on slanted plate 16, 16, and luminous device s1 may be attached at the upper edge of one (left) post 20 while photoreceptor s2 may be attached at the upper edge of the other (right) post 20. Such photoemitters/receptors s1, s2 comprise the snowfall sensor of the present invention. Luminous device s1 issues light or infrared rays and photoreceptor s2 receives them. The installation site of luminous device s1 and photoreceptor s2 should be several cm to 5 cm below height h of water discharge pipe 1 and at a position where left/right water discharge apertures 13 are not opened thereto. In addition, signal generators and receivers may be used instead of the luminous device s1 and photoreceptor s2 as snowfall sensors that generate and receive specific radio waves or signals.

The snow removal device that combines the snowfall sensors is used in the following manner. Light is issued from luminous device s1 toward photoreceptor s2 when snowfall is forecast. When snow S accumulates to near the bottom of water discharge pipe 1 (1a), as denoted by the broken line in FIG. 9, the light is blocked and that interruption alerts the inhabitants via a buzzer of chime. As a result, snow can be removed with good timing by operating of hot water heater 7 and pressurization pump P in the manner. In another mode, a timer that operates when photoreceptor s2 has not received light after continuation of the interruption of light for a fixed duration (for example, 10 to 20 minutes) could operate the hot water heater 7 and pressurization pump P in the same manner as above. Such an operation could be carried out by a control means mounted near the case B (for example, controller or personal computer). The result, as shown in FIG. 9, is that hot water w fed to water discharge pipe 1 (1a) via the connection pipe 1c is discharged slanted downward from left/right water discharge apertures 13 to melt snow S that had accumulated on roof R1. The dropping of the snow base to the eaves and then to the ground could be carried out with good timing and automatically. The elderly or single individuals can reliably and automatically carry out snow removal and follow-up operations by remote actuation of the water release valve 3 from within the house.

FIG. 10 is a general view showing a single-sided slanting roof R2 near ridge M. Water discharge pipes 1b fitted with water discharge apertures 13 on one side only (left side) is used in this case, as shown in FIG. 10. They are laid along the top of ridge M by a plurality of brackets k2. Bracket k2 is furnished with a slanted plate 16 laid on the surface of roof R2, support member 23 erected at its upper edge, and three-sided box-shaped member 24 positioned at the upper edge thereof that faces up. Water discharge pipe 1b is inserted and fixed in three-sided box-shaped member 24. As shown in FIG. 10, luminous device s1 is attached at the upper edge of prop 21 that has base 22 at a location before or behind brackets k2 on slanted plate 16 and photoreceptor s2 is attached at the upper edge of prop 26 that has arc-shaped base 25 on ridge M to complete the mounting of the snowfall sensor. The snow removal device can be operated in the similar manner even on the single-sided slanting roof R2 and it provides the same effects.

FIG. 11 is a perspective view showing the deployment of the snow removal device pursuant to the present invention on a hipped roof R3 of building H. As shown in FIG. 11, in building H having hipped roof R3 as well, pressurization pump P and hot water heater 7 deployed near narrow side wall W1 are connected to water discharge pipes 1, 1 slanting upward along each corner ridge C striking the ridge line of hipped roof R3 via vertical connection pipes 1c on the left/right of horizontal hot feed-water pipes 1f and elbow member 1e. Water discharge pipes 1, 1 merge into a single pipe at the top of two corners of ridge C and lie along the top of the ridge M. Branch pipe 1d fitted with water release valve 3 is connected to the bottom of connection pipe 1c. In addition, elbow member 1e comprises the resin pipe 10 and insulation cover 12.

In addition, water discharge pipe 1 on ridge M branches into two branches on the opposite side of ridge M (left side in FIG. 11) and they connect slanting downward along each corner ridge C. Each of these water discharge pipes 1 is mounted along ridge M of hipped roof R3 and corner ridge C via a plurality of brackets k1, k3, as shown in FIG. 11. Bracket k3 is a form of bracket k1 that is modified for corner ridge C. The lower edge of water discharge pipe 1 along each corner ridge C is connected to vertical water drain pipe 1g via the respective elbow members 1e, as shown on the left side of FIG. 11. Water release valve 3 is mounted at the lower edge of each water drain pipe 1g.

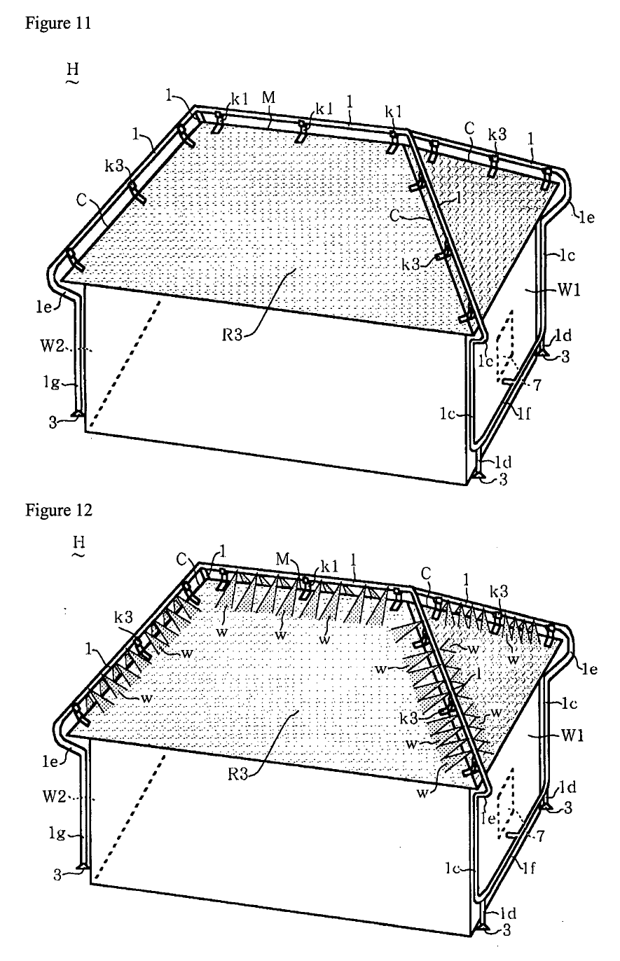

The snow removal device can reliably and safely remove snow from hipped roof R3 as well, as indicated above, through the expulsion of hot water w from hot water heater 7 and pressurization pump P in the same manner as above onto hipped roof R3 from the individual water discharge apertures 13 in a plurality of water discharge pipes 1 on each corner ridge C and in water discharge pipe 1 that lies along ridge M and corner ridge C, as shown in FIG. 12. The water discharge pipe 1 may be replaced by the water discharge pipe 1a.

Accordingly, snow can be removed safely without climbing onto hipped roof R3, which facilitates snow removal for the elderly or single individuals. Moreover, this device can be operated easily, can be maintained simply, can be produced or constructed at low cost, and has low operating costs.

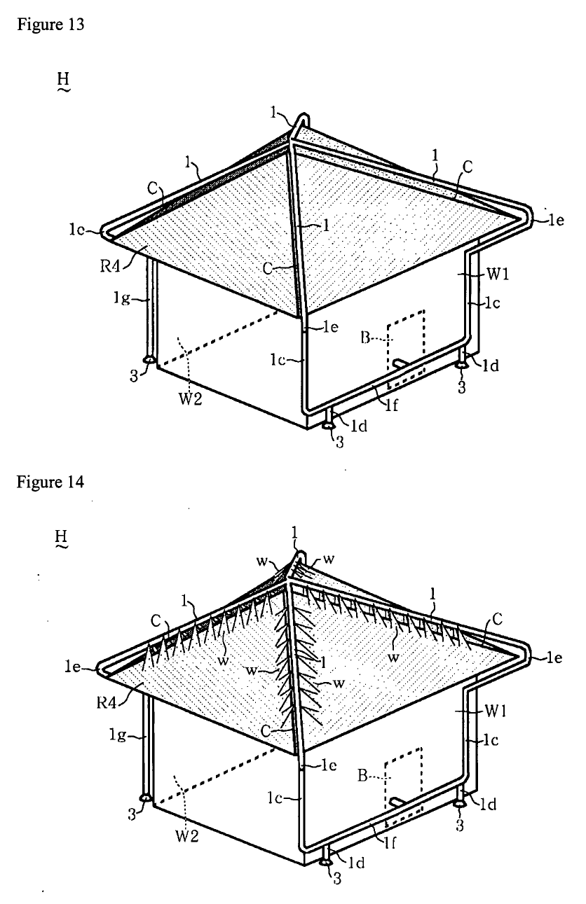

FIG. 13 is a perspective view showing the deployment of the snow removal device according to one embodiment of the present invention on square roof (quadrangular pyramidal) R4 of building H. As shown in FIG. 13, in building H having square roof R4, the pressurization pump P and hot water heater 7 are deployed near arbitrary narrow side wall W1 when all four walls have the same width, and these are connected to water discharge pipe 1 slanting upward along each of the corner ridges C striking each of the four ridge lines of square roof R4 via connection pipes 1c on the left/right from horizontal hot feed-water pipes 1f and elbow member 1e. Two water discharge pipes 1, 1 connected to the left/right connection pipes 1c merge at the apex of the four corner ridges C and branch into two pipes which then separately lie along each corner ridge C. Branch pipe 1d fitted with water release valve 3 is connected to the bottom of connection pipe 1c. The brackets (k3) that support water discharge pipe 1 are omitted from FIG. 13.

Furthermore, the bottom edge of water discharge pipe 1 tilted along each corner ridge C is connected to vertical water drain pipe 1g along side wall W2 on the opposite side from the narrow side wall W1 via respective elbow members 1e, as shown on the left side of FIG. 13. Water release valve 3 is installed at the bottom of each water drain pipe 1g. The snow removal device pursuant to the present invention can reliably and safely remove snow from square roof R4 as well, as indicated above, through the expulsion of hot water w from hot water heater 7 and pressurization pump P in the same manner as above onto roof R4 from the individual water discharge apertures 13 in a plurality of water discharge pipes 1 on each corner ridge C, as shown in FIG. 14. In another configuration, the connection pipe 1c may also be a single pipe, and hot water w may be provided via a single water discharge pipe 1 which may be branched into three water discharge pipes 1. The water discharge pipe 1 may be replaced by the water discharge pipe 1a in such a configuration as well.

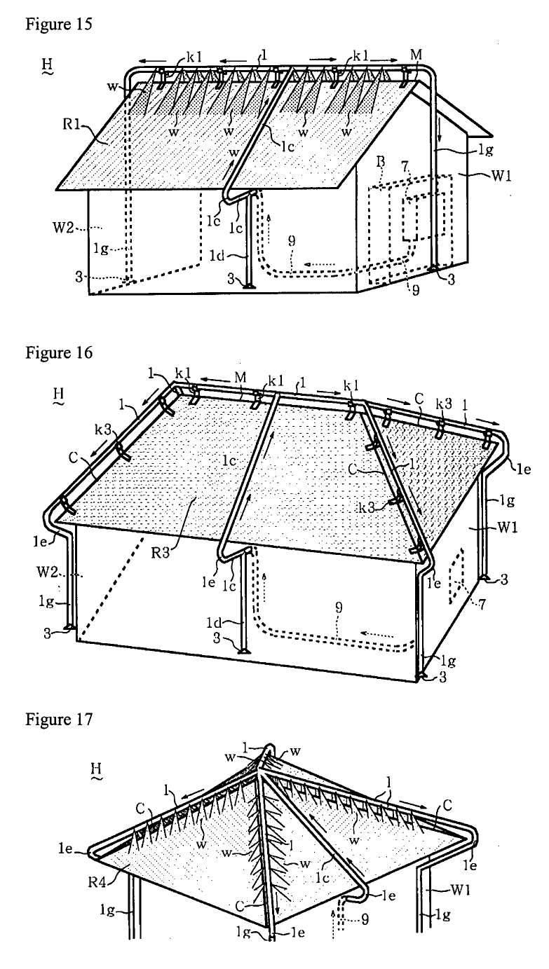

FIG. 15 is a perspective view showing another embodiment of the snow removal device applied to gabled roof R1. As shown in FIG. 15, hot water w prepared by hot water heater 7 is fed to connection pipe 1c outside from near the center of the comparatively long wall side positioned between narrow side walls W1 and W2 via hot water pipe 9 that is laid virtually horizontally inside building H. The connection pipe 1c rises near the center of one slanted surface of roof R1 via elbow member 1e at an eave and reaches virtually the center of ridge M. The position is near the center in a planar view of roof R1. The upper edge of the connection pipe 1c links to a pair of water discharge pipes 1, 1 that branch to the left/right along ridge M. Branch pipe 1d fitted with water release valve 3 is hung vertically below connection pipe 1c that is under elbow member 1e. Snowdrifts can be reliably removed from roof R1 since hot water w is fed into a left/right pair of water discharge pipes 1, 1 via connection pipe 1c, as shown in FIG. 15, and hot water w can be discharged at comparatively uniform pressure and volume over the entire roof R1 even when ridge M is long. The edges of the left/right pair of water discharge pipes 1, 1 are created to water drain pipes 1g that are vertically hung along narrow side walls W1 and W2 to permit drainage of residual hot water w from water release valve 3 at the bottom. In addition, the mode of ascent of connection pipe 1c near the center of the ridge M can be applied to the single-sided slanting roof R2 as well. In addition, water discharge pipe 1 may be replaced by the water discharge pipe 1a.

FIG. 16 is a perspective view showing another embodiment of the snow removal device pursuant that is applied to hipped roof R3. Hot water w prepared by hot water heater 7 is fed to the center of ridge M via connection pipe 1c that rises near the center of roof R3 from near the center of the comparatively long wall via hot water pipe 9 that is laid in the same manner as above. Hot water w is fed to four water discharge pipes 1 along the four corner ridges C via a left/right pair of water discharge pipes 1, 1 branching near the center of ridge M, as denoted by the arrows in FIG. 16. In such a configuration as well, snowdrifts can be reliably removed from hipped roof R3 even if ridge M of hipped roof R3 and corner ridge C are long.

FIG. 17 is a partial perspective view showing another embodiment of the snow removal device that is applied to square roof R4. As shown in FIG. 17, connection pipe 1c extends outside from arbitrary side wall W1 of building H in which the hot water heater 7 and hot water pipe 9 are mounted, and rises to the apex of square roof R4 (center) via elbow member 1e at the eave. It then links to four water discharge pipes 1 along four corner ridges C that branch from the position. Snowdrifts can be reliably removed from square roof R4 in such a configuration as well even if the four corner ridges C in square roof R4 are long. The water drain pipe 1g fitted with water release valve 3 at the bottom may be vertically hung below the elbow members 1e. Furthermore, when the widths on the opposite sides of four side walls differ in mutual pairs in building H having square roof R4 as shown in FIG. 17, the hot water pipe 9 and connection pipe 1c may be installed on the right side of longer side wall W1. In addition, water discharge pipe 1 may be replaced by the water discharge pipe 1a in each of the configurations as well.

Snow removal using the snow removal device according to one embodiment of the present invention was tested.

Water discharge pipe 1a (approximately 7 m total length, water discharge aperture 14 of 2 mm inner diameter×450 mm pitch) was mounted horizontally along the brackets k2 at a height of 30 cm along the ridge of the galvanized steel roof. Snowdrifts of a given height were laid over virtually the entire surface of the galvanized steel roof. Next, hot water w at approximately 50° C. was circulated through the water discharge pipes 1a (feedwater flow rate: 5 to 6 liters/minute). The hot water was continuously released toward the ridge side of the snowdrifts set on the galvanized steel roof from a plurality of water discharge apertures 14 that opened to the side of water discharge pipes 1a. Approximately 20 minutes after water discharge commenced, hot water of approximately 20° C. began to flow from the eave tip of the galvanized steel roof. Fissures in the snowdrifts on the galvanized steel roof began to appear at that point. The temperature of the water flowing from the eave tips was approximately 30° C. at the moment when such fissures began to appear. Subsequently, all of the snowdrifts on the galvanized steel roof suddenly fell to the ground from the side of the eave edge of the galvanized steel roof. The total duration from initiation of the trial until all of the snowdrifts on the galvanized steel roof had fallen was approximately 30 minutes.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A snow removal device for a building having sidewalls and a sloping roof with at least one of a ridge and a corner ridge, the device comprising:
a hot water heater;
a pressurization pump in fluid communication with the hot water heater;
a connection pipe;
a water discharge pipe connected to the hot water heater via the connection pipe, the water discharge pipe being configured to be installed in a direction along the ridge or the corner ridge, the water discharge pipe having horizontal or downwardly sloping water discharge apertures and downwardly facing water release apertures, the water discharge pipe being fixed to the building by brackets positioned to be higher than the ridge or the corner ridge.

2. The snow removal device of claim 1, wherein the connection pipe extends from one of the sidewalls of the building and connects to the water discharge pipe at a top edge of the one of the sidewalls.

3. The snow removal device of claim 1, wherein the water discharge pipe has a plurality of water discharge pipe portions branching along at least one of the ridge and the corner ridge, and the connection pipe rises near a center of the roof and is in fluid communication with the plurality of water discharge pipe portions.

4. The snow removal device of claim 1, wherein the connection pipe connecting between the water discharge pipe and the hot water heater has a water release valve.

5. The snow removal device of claim 1, wherein the water discharge apertures are formed in the water discharge pipe with first predetermined pitches, and the water release apertures are formed in the water discharge pipe with second predetermined pitches, the first predetermined pitches being shorter than the second predetermined pitches.

6. The snow removal device of claim 1, wherein the hot water heater is disposed in the building, the hot water heater being housed within a case having a door.

7. The snow removal device of claim 1, further having a snowfall sensor mounted above at least one of the ridge and the corner ridge and below the water discharge pipe, the snowfall sensor capable of detecting a snowfall.
